(19) United States
(12) Patent Application Publication
(10) Pub. No.: US 2009/0164675 A1
(43) Pub. Date: Jun. 25, 2009

(54) KVM SWITCH WITH A REMOTE CONTROL INCORPORATING A MEMORY CARD ADAPTER

(75) Inventors: Ya Lin Chen, Taipei city (TW); Ping Chung Hsiao, Sijhih city (TW)

Correspondence Address: YING CHEN;Chen Yoshimura LLP, 255 S. GRAND AVE., # 215, LOS ANGELES, CA, 90012, US

(73) Assignee: ATEN INTERNATIONAL CO., LTD., Taipei (TW)

(21) Appl. No.: 11/963,997

(22) Filed: Dec. 24, 2007

(51) Int. Cl. G06F 13/12

(52) U.S. Cl. 710/64

(57) ABSTRACT

A compact KVM switch with a remote selection control device that incorporates a memory card adapter is described. The KVM switch is adapted to connect two or more computers to a set of user interface devices, and is designed to dangle from a cable plugged into one of the user interface devices such as the monitor. The remote control is connected to the KVM switch housing by a thin cable and readily accessible by the user to conveniently select the computer to be connected to and managed by the user interface devices. A memory card adapter is provided on the remote control device and can be accessed by the currently selected computer. In one example, the remote control device has a disk shape with a selection button on its front face, and the memory card adapter has a card slot opening on the side of the disk shape.

### BACKGROUND OF THE INVENTION

1. Field of the Invention

This invention relates to KVM switches, and in particular, it relates to a KVM switch with a remote selection control device incorporating a memory card adapter.

2. Description of the Related Art

A KVM (Keyboard-Video-Mouse) switch enables a user to control multiple computers connected to the switch with one set of certain user interface devices, including a monitor, a pointing device and keyboard, for communicating with and otherwise managing the computers. From among the computers electrically connected by cable to a single KVM switch, a user selects, from time to time, which one of the computers such user interface devices are communicating with. The selection occurs, for example, when the user enters keystrokes from the keyboard to switch from one computer to another. Thus, all such connected computers may share the same user interface devices.

U.S. Pat. No. 7,035,112 describes a miniature KVM switch. Compared to conventional KVM switches, the switch is small enough and with few enough connections that it can be installed so it no longer competes (e.g. with the keyboard and monitor) for desktop surface area. This kind of switch is sometimes referred to as a cable KVM switch.

US Patent Application Publication No. 2005/0225935 describes a KVM switch that includes a storage device configured inside.

### SUMMARY OF THE INVENTION

The present invention is directed to a KVM switch with a remote selection control device incorporating a memory card adapter.

An object of the present invention is to provide a KVM switch that provides convenient access to a compact storage device that can be shared by multiple computers.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a KVM switch system for connecting a set of user interface devices and at least two computers which includes: a housing; switch circuitry enclosed in the housing; a plurality of connectors electrically connected to the switch circuitry, including a set of one or more first connectors for electrically connecting to the user interface devices and at least two sets of one or more second connectors each set for electrically connecting to one of the computers; and a remote control device physically connected to the housing by a remote control cable and electrically connected to the switch circuitry, the remote control device including a selection switch for generating a selection signal and a memory card adapter for receiving a memory card, wherein the switch circuitry selectively electrically connects the set of user interface devices and the memory card adapter to one of the two or more computers in accordance with the selection signal generated by the selection switch.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a KVM switch system with a remote control.

FIG. 2A schematically illustrates a KVM switch system according to an embodiment of the present invention.

FIG. 2B schematically illustrates an exploded view of the remote control portion of KVM switch system of FIG. 2A.

FIG. 3 is a block diagram of a KVM switch system according to an embodiment of the present invention.

FIGS. 4A-4D illustrate a switching operation performed by a KVM switch in response to the operation of its remote control, according to an embodiment of the present invention.

### DETAILED DESCRIPTION OF THE PREFERRED EMBODIMENTS

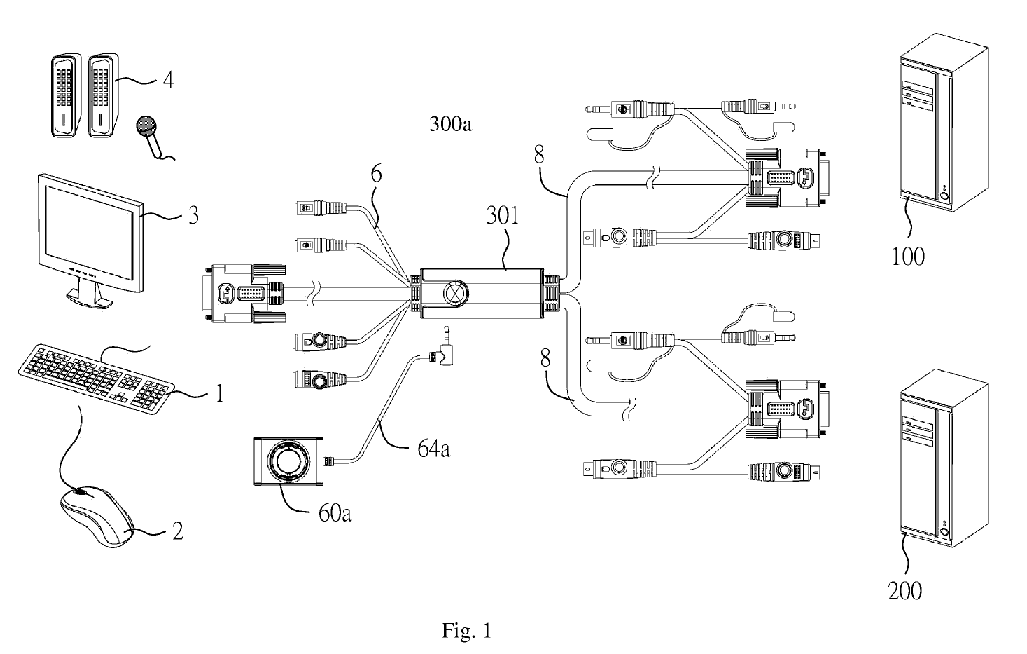

FIG. 1 illustrates a KVM switch system currently marketed by the assignee of the present invention. In this disclosure, a KVM switch refers to a KVM switch that is not intended to be placed on a flat surface such as a table or desk top or to be rack mounted, but is intended to dangle from one of its cables plugged into a computer or a peripheral device. As shown in FIG. 1, the KVM switch system includes a KVM switch 300a having switch circuitry enclosed in a housing 301, a cable 6 extending from the housing 301 that branches into one set of cables with respective connectors for connecting to a set of user interface devices, and two cables 8 extending from the housing 301 each branching into a set of cables with respective connecters for connecting to a computer 100 or 200. The set of user interface devices includes a keyboard 1, a pointing device (e.g. a mouse) 2, a monitor 3, and audio devices 4 which include speakers and a microphone in this example. When the cable 6 is plugged into the user interface devices, the KVM switch 300a dangles from the cable 6. In one particular example, the KVM switch 300a dangles from the branch cable that plugs into the back of the monitor 3 which is typically thicker than the branch cable for a keyboard or mouse. The KVM switch 300a functions to selectively connect the set of user interface devices to one of the two computers 100 and 200. A remote control device 60a is provided to perform the selection function. The remote control device 60a is connected to the KVM switch 300a by a thin cable 64a so that it is readily accessible by the user, and includes a remote selection switch 61 (such as a toggle switch button) which can be conveniently used by the user to select which computer is to be electrically connected to the user interface devices.

According to embodiments of the present invention, an improved KVM switch system has a remote control that incorporates a memory card adapter, so that the memory card adapter can be shared among all the computers connected to the switch.

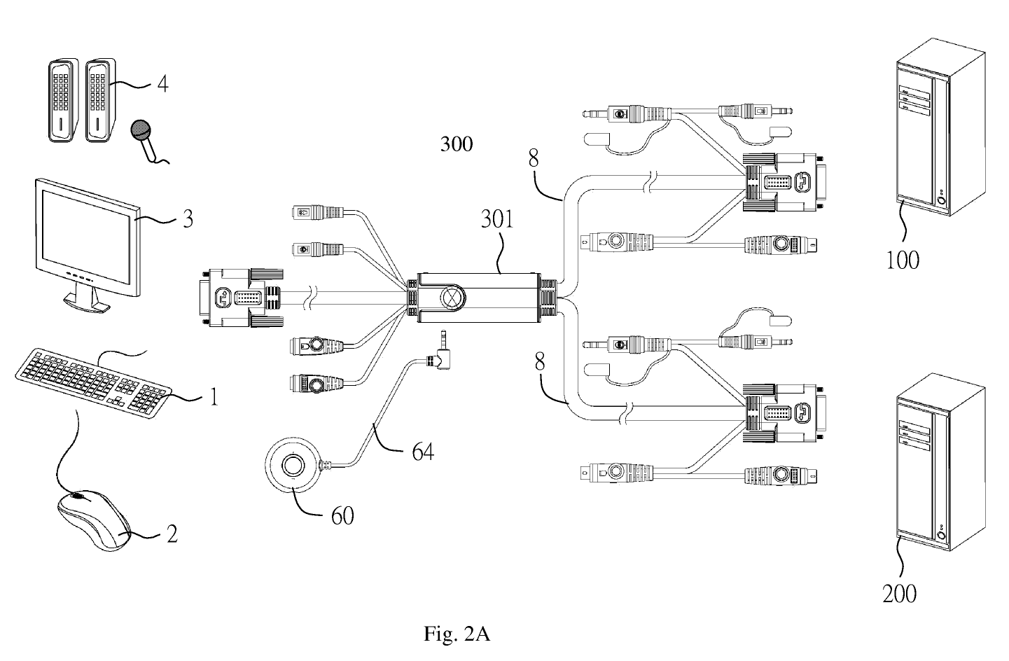

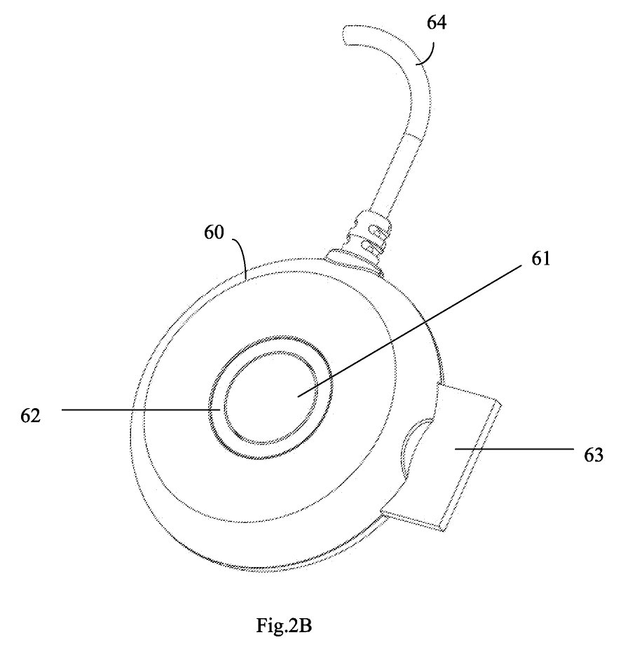

FIGS. 2A and 2B illustrate an improved KVM switch system according to an embodiment of the present invention. Similar or identical components in FIGS. 1 and 2A are labeled with similar or identical reference numbers and repetitive descriptions are omitted. As shown in FIG. 2A, the KVM switch system includes a KVM switch 300 having switch circuitry enclosed in a housing 301, a cable 6 extending from the switch housing 301 for connecting to a set of user interface devices, two cables 8 extending from the switch housing 301 for connecting to computers 100 and 200, and a remote control device 60 connected to the KVM switch 300 by a thin cable 64. The remote control 60 includes a remote selection switch 61, such as a toggle switch button, which can be conveniently used by a user to select which computer is to be connected to the user interface devices. The KVM switch 300 functions to electrically connect the user interface devices to one of the two computers 100 and 200 in accordance with the user's selection by the remote control device. Although only two computers are shown in this illustration, the cable switch may be made to connect to and select from more computers.

As shown in FIG. 2B, the remote control device 60 incorporates a memory card adapter 63. A memory card controller for controlling access to the memory card can be located either in the adapter 63 or in the KVM switch 300. In other words, the memory card adapter 63 may be a passive adapter without a memory card controller or a card reader with the controller. In the example shown in FIG. 2B, the remote control 60 has a disk-like shape with a front and back face, and the button 61 is located at the center of the front face. The memory card adapter 63 has a physical form of a narrow card slot opening on the side of the disk shape. The size of a typical memory card slot is sufficiently small so that the overall size (diameter) of the remote control 60 is about 1 to 2 inches.

The remote control device 60 is optionally provided with an indicator 62, such as an LED, to indicate which computer is currently connected to the user interface devices. Additionally, the indicator 62 may indicate (e.g. by flashing) when the memory card is currently being accessed, such as during a read or write operation. Alternatively, a separate memory card indicator (not shown) may be provided to indicate when the memory card is being accessed.

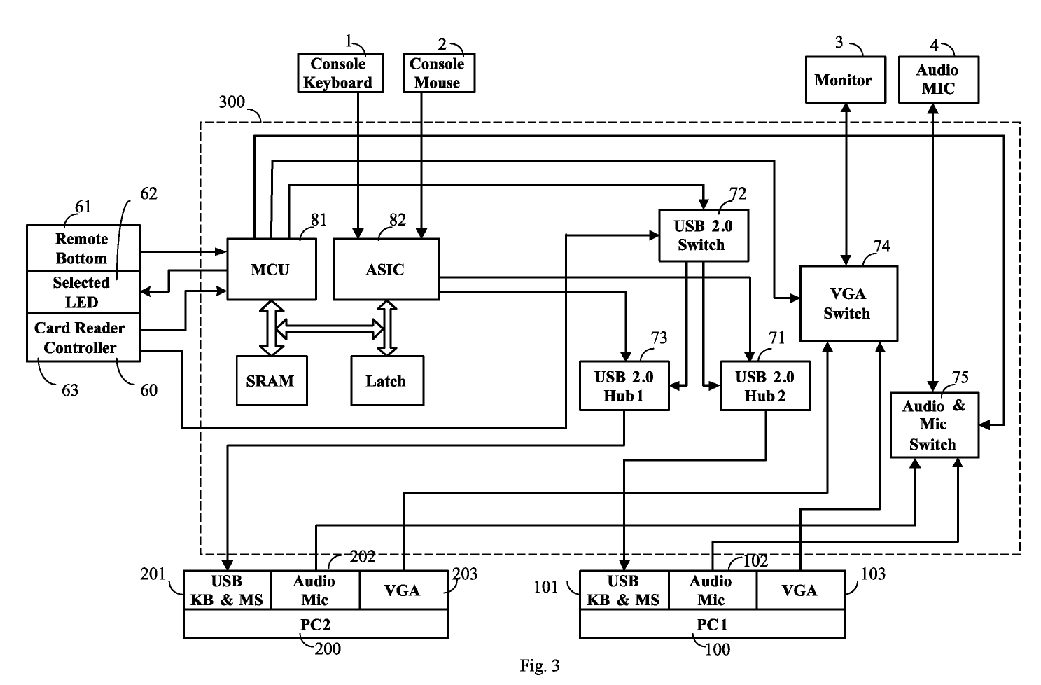

FIG. 3 is a block diagram illustrating the electrical relationships among the components of the KVM switch system according to an embodiment of the present invention. The components within the dashed lines constitute a switch circuitry which is enclosed in the switch housing 301. The KVM switch 300 has three kinds of outside connections: those for the remote control 60, (including the memory card adapter 63, the indicator such as the LED display 62, and the remote selection button 61); those for the user interface devices (keyboard 1, mouse 2, monitor 3, and audio devices 4); and those for each of the two computers 100 and 200. Each computer connection includes connections with a USB port 101 or 201, an audio port 102 or 202, and a video (VGA) port 103 or 203. Of course, the KVM switch 300 may allow different numbers of computers connected to it. Although four user interface devices (keyboard 1, mouse 2, monitor 3, and audio device 4) are shown in FIG. 3, it is possible for there to be only a keyboard or only a mouse. Further, the audio devices 4 shown in FIG. 3 include both speakers and microphones, but speakers and microphone may be separate devices.

As shown in FIG. 3, the KVM switch 300 includes an MCU 81, a circuit such as an ASIC 82, a video switch 74, an audio switch 75, a USB switch 72, and two USB hubs 71 and 73. Generally, there are as many USB hubs as the maximum number of computers to be managed by the KVM switch (two computers in this example). The upstream ports of the USB hubs 71 and 73 are connected to the USB ports 101 and 201 of the computers 100 and 200, respectively, for transmitting and receiving USB signals. The audio switch 75 is connected to the audio port 102 and 202 of the computers 100 and 200 for transmitting and receiving audio signals (including speaker signals and microphone signals). The video switch 74 is connected to the VGA ports 103 and 203 of the computers 100 and 200 for receiving video (monitor) signals.

The MCU 81 is connected with the remote selection button 61 to receive a selection signal from the user's manipulation of the remote selection button 61. The MCU 81 also transmits an indication signal to the LED display 62 for the LED to signal which computer is currently connected to the user interface devices. The MCU 81 is connected to the ASIC 82 by a data and address bus for controlling the ASIC 82. The MCU 81 also connects with the USB switch 72, the video switch 74, and the audio switch 75 for controlling these switches.

The memory card adapter 63 is connected to the USB switch 72 for sending and receiving USB signals. In the illustrated example, the card reader controller is located in the remote control device 60. The USB switch 72 operates to selectively (under the control of the MCU 81) send and receive these signals to and from one of the USB hubs 71 or 73. The keyboard 1 and the mouse 2 are connected to the ASIC 82 to transmit their respective signals to it. The ASIC 82 processes the keyboard and mouse signals to generate keyboard and mouse signals conforming to the USB protocol, and operates to selectively (under the control of the MCU 81) transmit the resulting keyboard and mouse signals to one of the USB hubs 71 and 73. The monitor 3 receives its video signals from a connection to the video switch 74, which operates to selectively (under the control of the MCU 81) send the video signals from the VGA ports of one of the computers 103 or 203 to the monitor. The audio switch 75 is connected to the audio devices 4 and operates to selectively (under the control of the MCU 81) audio signals between the audio devices and the audio ports 102 or 202 of one of the computers.

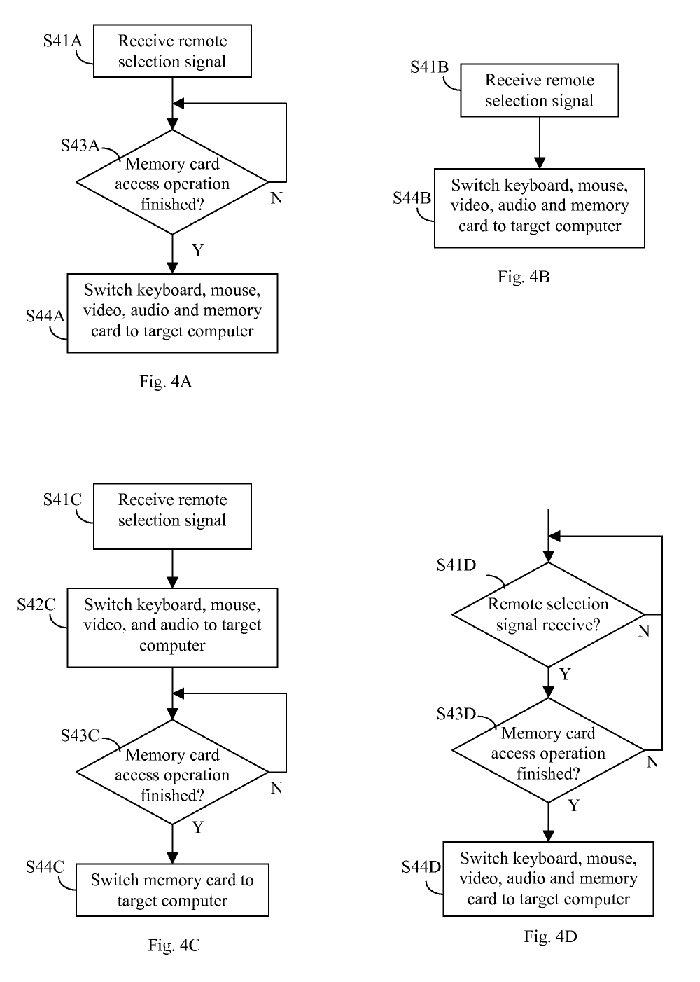

In normal operation, the MCU 81 controls the ASIC 82, the USB switch 72, the video switch 74 and the audio switch 75 to connect one of the two computers 100 and 200 to the user interface devices. When the user presses the remote selection button 61 to change the selection of computer, and if the memory card adapter 63 is not in the middle of a memory card access operation, the MCU 81 controls the various switches to switch the user interfaces devices as well as the memory card adapter 63 to the target computer. In the event the memory card adapter 63 is carrying out a memory card access operation (i.e. “busy”) at the moment the user presses the remote selection button 61, embodiments of the present invention provide for a response according to one of the following four different methods, as shown by FIGS. 4A-4D.

In the first method (FIG. 4A), after receiving the remote selection signal from the remote selection button 61 requesting a switch from the currently connected computer to a target computer (step S41A), the switching of the user interface devices and the memory card adapter (step S44A) is delayed until after the memory card access operation of the memory card adapter is finished (“Y” in step S43A). More specifically, the MCU 81 receives the remote selection signal from the remote control device 60, and senses the memory card adapter 63 is busy and does nothing further until it senses otherwise, at which point the MCU 81 sends appropriate control signals to the ASIC 82, the USB switch 72, the video switch 74, and audio switch 75 to effect the selection of the target computer. The MCU 81 has knowledge of the status of the memory card adapter 63 because when the memory card adapter 63 sends the signal to USB switch, the controller in the memory card adapter also send a signal about its status to the MCU 81 at the same time.

In the second method (FIG. 4B), upon receiving the remote selection signal from the remote control 60 (step S41B), the switching of the user interface devices and the memory card adapter (step S44B) is performed immediately. This will cause the memory card access operation to be interrupted and loss of data will likely entail.

In the third method (FIG. 4C), upon receiving the remote selection signal from the remote control 60 (step S41C), the switching is performed immediately for the user interface device (the keyboard, mouse, video and audio) (step S42C), but the switching of the memory card adapter (step S44C) is delayed until after the memory card access operation is finished (“Y” in step S43C). More specifically, the MCU 81 receives the remote selection signal from the remote control 60, but senses that the memory card adapter 63 is busy. The MCU 81 sends control signals to the ASIC 82, the video switch 74, and the audio switch 75 to immediately effect the selection of the computer for the user interface devices. When the MCU 81 senses that the memory card access operation is finished, it sends a control signal to the USB switch 72 to connect the memory card adapter 63 to the target computer.

In the fourth method, no switching is performed if the remote selection signal is received when the memory card adapter is carrying out a memory card access operation. In other words, the remote selection signal is ignored. Thus, no switching will occur unless the remote selection signal is again received when the memory card adapter is no longer busy. To effect the selection of a different computer, the user must repeat the pressing of the remote control button when the memory card adapter is no longer busy. More specifically, as shown in FIG. 4D, when a remote selection signal is received by the MCU 81 (“Y” in step S41D), the MCU determines whether the memory card access operation is finished (step S43D). If it is finished (“Y” in step S43D), the MCU controls the various circuit components to switch the keyboard, mouse, video, audio and memory card to the target computer (step S44D). If, when a remote selection signal is received, the memory card access operation is not yet finished (“N” in step S43D), the process loops back and the MCU 81 waits for the remote selection signal.

The switch 300 may implement any of the above methods, or alternatively, it may allow the user to control which of these methods is used through a software interface.

The descriptions speak of the memory card adapter 63 carrying out a memory card access operation or being busy; of course, if should be understood that when the memory card adapter 53 is a passive adapter, it is the memory card reader controller in the KVM switch 300 that controls the memory card access operation.

In the illustrated embodiments, the cables that connect to the user interface devices and the computers are integrated with the housing of the KVM switch 300 and have connectors at their ends. Alternatively, instead of integrated cables, the KVM switch may provide connectors on its housing to receive cables for connecting to the user interface devices and/or the computers. When the connectors are provided on the switch housing, the connector for the set of user interface devices is preferably a combined connector that transmits all necessary signals for the user interface devices, so that an adaptor cable for the user interface devices can be plugged into the combined connector. The adaptor cable may have a plurality of connectors at the other end for separately plugging into the various user interface devices. Likewise, if a connector is provided on the switch housing to connecting to a computer, the connector may be a combined connector for receiving an adapter cable for the computer. Further, in the embodiment illustrated in FIG. 2A, the remote control device 60 has a thin cable and can be plugged into a remote control port on the housing 301 of the switch 300. Alternatively, the thin cable for the remote control device may be integrated with the housing of the switch.

Although the set of user interface devices shown in FIGS. 2A and 3 includes audio devices (speakers and microphone), the audio devices are optional. If no audio devices are provided, the audio switch 75 can be omitted.

Although the KVM switch shown in FIG. 2A is a KVM that is intended to dangle from one of its cables plugged into a computer or a peripheral device, the remote control with a memory card adapter may also be used with a KVM switch that is intended to be places on a flat surface or rack mounted.

It will be apparent to those skilled in the art that various modification and variations can be made in the method and apparatus of the present invention without departing from the spirit or scope of the invention. Thus, it is intended that the present invention cover modifications and variations that come within the scope of the appended claims and their equivalents.

What is claimed is:

1. A KVM switch system for connecting a set of user interface devices and at least two computers, comprising:
a housing;
switch circuitry enclosed in the housing;
a plurality of connectors electrically connected to the switch circuitry, including a set of one or more first connectors for electrically connecting to the user interface devices and at least two sets of one or more second connectors each set for electrically connecting to one of the computers; and
a remote control device physically connected to the housing by a remote control cable and electrically connected to the switch circuitry, the remote control device including a selection switch for generating a selection signal and a memory card adapter for receiving a memory card,
wherein the switch circuitry selectively electrically connects the set of user interface devices and the memory card adapter to one of the two or more computers in accordance with the selection signal generated by the selection switch.

2. The KVM switch system of claim 1, wherein the remote control device has a disk shape, wherein the selection switch is a switch button on a front face of the disk shape, and wherein the memory card adapter is in the form of a narrow slot opening on a side of the disk shape.

3. The KVM switch system of claim 1, wherein the remote control device further includes an indicator to indicate which computer is currently electrically connected to the user interface devices.

4. The KVM switch system of claim 1, wherein the remote control device further includes an indicator to indicate whether the memory card is currently being accessed.

5. The KVM switch system of claim 1, wherein the memory adapter includes a memory card controller for controlling access to the memory card.

6. The KVM switch system of claim 1, further comprising at least one connection cable extending from the housing, wherein some of the connectors are located at a distal end of the connection cable.

7. The KVM switch system of claim 1, wherein at least some of the connectors are located on the housing.

8. The KVM switch system of claim 1, further comprising:
a first cable extending from the housing, wherein the set of first connectors are located at a distal end of the first cable; and
two or more second cables extending from the housing, wherein the two or more sets of second connectors are located at distal ends of the second cables, respectively.

9. The KVM switch system of claim 8, wherein when one of the first connectors is connected to one of the user interface devices, the housing dangles from the first cable.

10. The KVM switch system of claim 1, wherein the switch circuitry comprises:
a first set of one or more switch circuits connected to the set of first connectors and to each of the computers for selectively electrically connecting the first connectors to one of the computers;
a second switch circuit connected to the memory card adapter and to each of the computers for selectively electrically connecting the memory card adapter to one of the computers; and
a control circuit connected for receiving the selection signal from the remote control device, the control circuit controlling the first set and second switch circuits to select the computer to connect to.

11. The KVM switch of claim 10, wherein if the control circuit receives the selection signal from the remote control device requesting a switch from a currently connected computer to a target computer when the memory card adapter is performing a memory card access operation under control of the currently connected computer, the control circuit controls the first set of switch circuits to connect the first connectors to the target computer immediately, and controls the second switch circuit to connect the memory card adapter to the target computer after the memory card access operation is finished.

12. The KVM switch of claim 10, wherein if the control circuit receives the selection signal from the remote control device requesting a switch from a currently connected computer to a target computer when the memory card adapter is performing a memory card access operation under control of the currently connected computer, the control circuit controls the first set of switch circuits to connect the first connectors to the target computer and controls the second switch circuit to connect the memory card adapter to the target computer immediately.

13. The KVM switch of claim 10, wherein if the control circuit receives a selection signal from the remote control device requesting a switch from a currently connected computer to a target computer when the memory card adapter is performing a memory access operation under control of the currently connected computer, the control circuit controls the first set of switch circuits to connect the first connectors to the target computer and controls the second switch circuit to connect the memory card adapter to the target computer after the memory access operation is finished.

14. The KVM switch of claim 10, wherein if the control circuit receives the selection signal from the remote control device requesting a switch from a currently connected computer to a target computer when the memory card adapter is performing a memory card access operation under control of the currently connected computer, the control circuit ignores the selection signal.

15. The KVM switch system of claim 10, wherein the first connectors transmit keyboard, mouse, video, and audio signals, and wherein the first set of switch circuits includes:
a circuit for processing the keyboard and mouse signals and selectively transmitting the processed keyboard and mouse signals to one of the computers;
a video switch for selectively transmitting the video signals from to one of the computers to the first connectors; and
an audio switch for selectively transmitting the audio signals between the first connectors and one of the computers.

16. The KVM switch system of claim 15, wherein the processed keyboard and mouse signals from the circuit are USB signals, wherein the memory card adapter receives and generates USB signals, wherein the second switch circuit is a USB switch, and wherein the KVM switch system further comprises at least two USB hubs each having an upstream port connected to one of the computers, each USB hub having one downstream port connected to the USB switch and another downstream port connected to the circuit.

17. The KVM switch system of claim 1, further comprising:
two or more cables extending from the housing, wherein the two or more sets of second connectors are located at distal ends of the cables, respectively.

18. The KVM switch system of claim 17, wherein the switch circuitry comprises:
a first set of one or more switch circuits connected to the set of first connectors and to each of the computers for selectively electrically connecting the first connectors to one of the computers;
a second switch circuit connected to the memory card adapter and to each of the computers for selectively electrically connecting the memory card adapter to one of the computers; and
a control circuit connected for receiving the selection signal from the remote control device, the control circuit controlling the first set and second switch circuits to select the computer to connect to.

19. The KVM switch of claim 18, wherein if the control circuit receives the selection signal from the remote control device requesting a switch from a currently connected computer to a target computer when the memory card adapter is performing a memory card access operation under control of the currently connected computer, the control circuit controls the first set of switch circuits to connect the first connectors to the target computer immediately, and controls the second switch circuit to connect the memory card adapter to the target computer after the memory card access operation is finished.

20. The KVM switch of claim 18, wherein if the control circuit receives the selection signal from the remote control device requesting a switch from a currently connected computer to a target computer when the memory card adapter is performing a memory card access operation under control of the currently connected computer, the control circuit controls the first set of switch circuits to connect the first connectors to the target computer and controls the second switch circuit to connect the memory card adapter to the target computer immediately.
